(19) United States
(12) Patent Application Publication
(10) Pub. No.: US 2002/0099740 A1
(43) Pub. Date: Jul. 25, 2002

(54) Method, apparatus, media and signals for simplifying a program listing

(76) Inventor: Kyle N. Patrick, St. Maple Ridge (CA)

Correspondence Address: INTERNATIONAL BUSINESS MACHINES CORPORATION, INTELLECTUAL PROPERTY LAW, DEPT. QPZA/ 210, 8501 IBM DRIVE, CHARLOTTE, NC, 28262, US

(21) Appl. No.: 09/981,701

(22) Filed: Oct. 17, 2001

(30) Foreign Application Priority Data
Jan. 23, 2001 (CA) 2,332,102

(51) Int. Cl. G06F 15/00

(52) U.S. Cl. 707/526; 707/514

(57) ABSTRACT

A method, apparatus computer readable medium and signals for simplifying a program listing are disclosed. Generally, each involves receiving an identification of a portion of a program listing to be hidden, receiving input indicating that the portion is to be hidden, and causing a symbol to replace the portion of the program listing in response to the identification and the input indicating the portion is to be hidden. This functionality may be imparted to a text editor normally used to produce a program listing, or may be provided as an enhancement to a text editor.

### BACKGROUND OF THE INVENTION

1. Field of Invention

This invention relates to text editors and more particularly to enhancements to text editors for simplifying a program listing.

2. Description of Related Art

Program code written by programmers is becoming increasingly complex. Many text editors provide for an organized listing of program code using separate lines for different functional statements, delimiters after functional statements, and indentation to identify portions of code of a common context within the program. Different contexts of code portions in a program listing are often shown in a hierarchical fashion.

One problem with current technology in providing program listings is that all details of the program listing are displayed. For particularly large and complex program listings, this can result in the display of a large quantity of unnecessary detail of the program, that is often irrelevant detail to analyses a programmer may be undertaking. Currently, the most common means of reducing complexity is to change the structure of the program, by decomposing the program into small units of work called procedures. This decomposition is not always feasible due to the interaction between variables and control blocks. What would be desirable is to have a reasonable way of reducing the amount of code displayed at one time on the screen.

### SUMMARY OF THE INVENTION

The present invention addresses the above need by providing a method and apparatus for simplifying a program listing involving receiving an identification of a portion of the program listing to be hidden, receiving input indicating the portion is to be hidden, and causing a symbol to replace the portion of the program listing in response to the identification and the input indicating that the portion is to be hidden. In one embodiment, the above functionality can be provided by computer executable instructions for directing a processor circuit to carry out the above functions. Such instructions may be provided on a processor readable medium or through a communications interface, for example.

Receiving the identification may involve receiving identifications of a start character position and an end character position identifying a beginning and ending respectively of the portion of the program listing to be hidden. The method may further involve determining the start character position and the end character position.

Determining the start character position and the end character position may involve identifying a portion of the program listing which is in a common context. This may be done by identifying a context of a portion of the program listing at a cursor position, where the context identified is the common context. Identifying the context may involve locating a context start marker in proximity to the cursor, determining a hierarchical level of the context start marker and locating a context end marker for the context identified by the context start marker.

The act of causing a symbol to replace the portion of the program listing which is to be hidden may involve associating that portion of the program listing which is to be hidden with the symbol. This may further involve associating the start character position and the end character position with the symbol. Associating may involve producing a hide record identifying the start character position and the end character position.

Causing the symbol to replace the portion of the program listing may involve showing the symbol instead of characters between the start character position and the end character position of the program listing when the characters between the start character position and the end character position would otherwise be shown.

Showing the symbol may involve loading an index to the symbol at a position in a display buffer which would normally be occupied by the portion to be hidden and loading into the display buffer after the index, a following portion of the program listing, which is to be shown.

The method may further involve redisplaying at least one portion of the program which has been hidden. Alternatively, all hidden portions of the program listing may be redisplayed. This may be achieved by deleting one or all hide records identifying hidden portions of the program listing.

In accordance with another aspect of the invention there is provided an apparatus for simplifying a program listing. The apparatus includes a processor circuit having an output device and a text editor for providing a representation of a program listing using the output device. The apparatus further includes provisions for receiving an identification of a portion of the program listing to be hidden, provisions for receiving input indicating that the portion is to be hidden and provisions for causing a symbol to replace the portion of the program listing in response to the identification and the input indicating the portion is to be hidden.

In accordance with another aspect of the invention there is provided a computer readable medium for providing processor executable instructions for directing a processor circuit executing a text editor to receive an indication of a portion of a program listing provided by the text editor to be hidden, to receive input indicating the portion is to be hidden, and to cause a symbol to replace the portion of the program listing in response to the identification and the input indicating the portion is to be hidden.

In accordance with another aspect of the invention, there is provided an apparatus for simplifying a program listing, where the apparatus includes the computer readable medium described above and further includes a processor circuit having an output device for producing the program listing, and a text editor for causing the program listing to be displayed by the output device. The apparatus further includes an input device operable to receive the identification of the portion of the program listing to be hidden. In accordance with another aspect of the invention, there is provided a computer data signal having a first code segment for directing a processor circuit executing a text editor operable to provide a program listing, to receive an identification of a portion of the program listing which is to be hidden, a second code segment for directing the processor circuit to receive an input indicating the portion is to be hidden, and a third program portion for directing the processor circuit to cause a symbol to replace the portion of the program listing in response to the identification and the input indicating the portion is to be hidden.

In one sense the invention provides for hiding or collapsing a code block displayed by a code editor, while preserving scope and coupling of the hidden code block and without making changes to the structure of the program. In other words it limits the information displayed to the programmer at any given time, to only the information selected by the programmer as being of interest for display.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is a block diagram of an apparatus according to a first embodiment of the invention;

FIG. 2 is a program listing having a portion which is desirable to be hidden;

FIG. 3 is a pictorial representation of a context sensitive menu provided by an enhancement, according to the first embodiment of the invention;

FIG. 4 is a flowchart of an automated selection routine provided by the enhancement;

FIG. 5 is a flowchart of a hide routine provided by the enhancement;

FIG. 6 is a flowchart of a display routine provided by the enhancement;

FIG. 7 is the program listing of FIG. 2 with a symbol replacing a hidden portion of the program listing;

FIG. 8 is a flowchart of a restore routine provided by the enhancement; and

FIG. 9 is a flowchart of a restore all routine provided by the enhancement.

### DETAILED DESCRIPTION OF PREFERRED EMBODIMENTS OF THE INVENTION

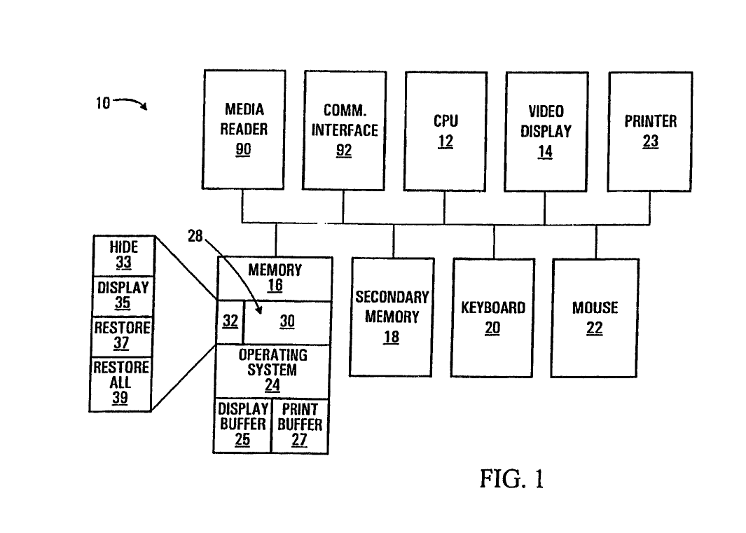

Referring to FIG. 1, an apparatus according to a first preferred embodiment of the invention is shown generally at 10. In this embodiment, the apparatus includes a computer system having a processor circuit, which in this embodiment is provided by a central processing unit (CPU) 12 that is coupled to a display 14, a keyboard 20, and a mouse 22. It will be appreciated that alternatively the processor circuit may be a micro-controller, or a distributed multiple processor system, for example.

The CPU 12 has access to primary memory 16 and secondary memory 18. The primary memory 16 may be realized as a number of different types of memory devices, including RAM devices, ROM devices, EPROM devices or EEPROM devices. The secondary memory 18 may be of any of a number of different secondary storage devices including a hard disk device, for example.

The primary memory 16 holds a copy of an operating system 24 and a display buffer 25 for holding information to be displayed on the display 14. The primary memory 16 may also hold a print buffer 27 for holding information to be printed by a printer 23 which may be controlled by the CPU 12.

For purposes of discussion below, it will be assumed that the operating system 24 is the “MICROSOFT” WINDOWS 95 operating system from Microsoft Corporation of Redmond, Wash.

In this embodiment, the primary memory 16 is further loaded with an application program which, in this embodiment includes an enhanced text editor 28 comprising a conventional text editor 30 and an enhancement 32. The conventional text editor 30 may include a first set of instructions for directing the CPU 12 to carry out the conventional functions of a text editor such as VISUAL AGE7 by IBM, or Visual J++7 and/or VISUAL C++, both by Microsoft Corporation of Redmond, Wash., for example. The enhancement 32 includes a second set of instructions which may be integrated into the enhanced text editor 28 or which may be provided as a separate entity, with an interface to interact with the conventional text editor 30.

Regardless of whether the enhancement 32 is provided separate or apart from the conventional text editor 30, the effect of the enhancement when run by the CPU 12, is to provide for the simplification of a program listing such as may be provided on the display 14 or printed by the printer 23, so that a complex code listing produced by the conventional text editor 30 can be simplified to permit the user to get an overview of the complex code by eliminating details of the textual representations of specific blocks of code in particular portions of the listing. The enhancement 32 effectively directs the CPU 12 to receive an indication of a portion of the program listing to be hidden, in this embodiment, through user manipulation of the mouse 22 or keyboard 20, and to receive input from the user, through the mouse 22 or keyboard 20 indicating that the portion is to be hidden, and to cause a symbol to replace the portion of the program listing intended to be hidden, when the program listing is produced. In other words, the user can select a particular portion of the listing to be hidden and when a program listing is produced, rather than displaying the portion intended to be hidden, a symbol is shown in its place. Similarly, different portions of the program listing can be selected to be hidden and each may be replaced with its own individual symbol or the same symbol, when a program listing is produced. In addition, the user can provide input to cause the CPU 12 to cause a previously hidden program portion to be redisplayed and conveniently, the user may select that all hidden portions be redisplayed, in which case the entire program listing is capable of being redisplayed in the conventional fashion.

To achieve the above functionality, the enhancement 32 includes a hide segment 33 for providing hide functionality, a display segment 35 which interacts with the conventional text editor 30 to cause a conventional display routine thereof to display symbols instead of hidden text, a restore segment 37 which provides restore functionality, to cause the selected text to be redisplayed, and a restore all segment 39 which provides restore functionality so that all hidden text is redisplayed.

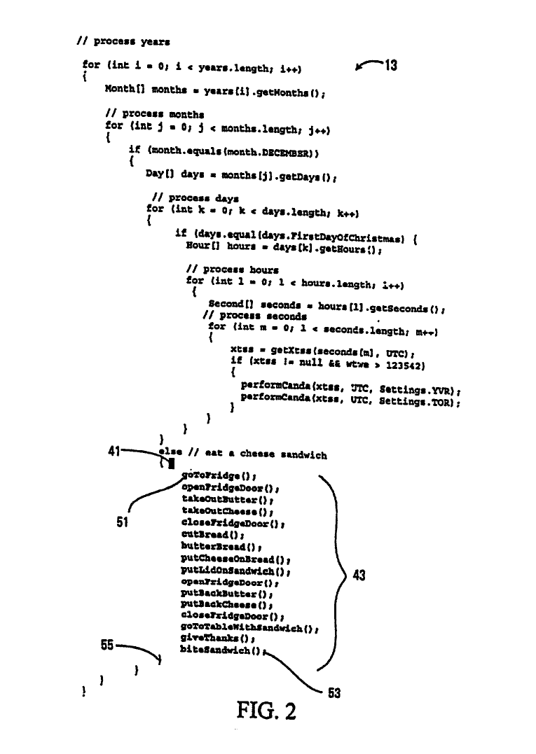

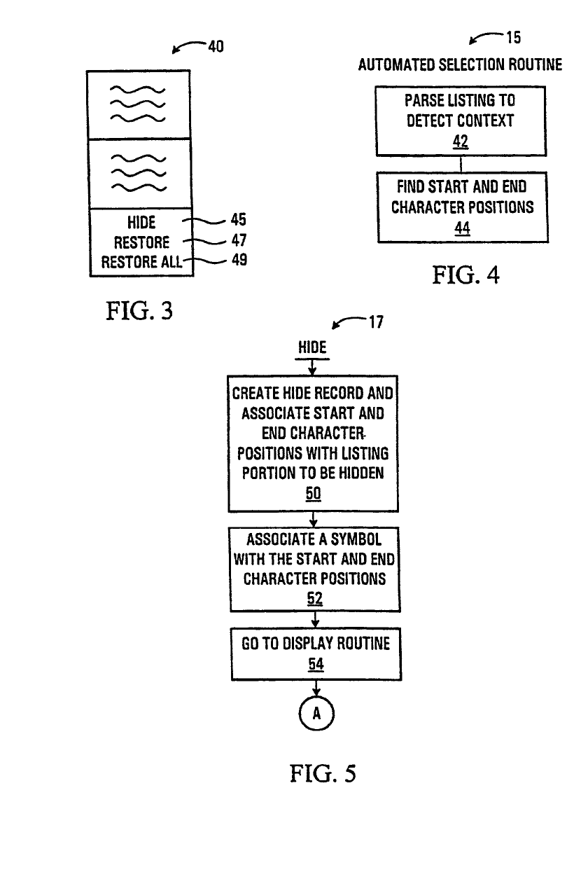

Referring to FIG. 1, with the CPU 12 running the conventional text editor 30 and the enhancement 32, a user will manipulate the mouse 22 or keyboard 20 to direct the conventional text editor 30 to display a program listing on the display 14, in the usual manner. Then, referring to FIGS. 1 and 2, also using the mouse 22 or keyboard 20, the user may position a cursor 41, produced by the operating system 24, on the display 14, at a location in the program listing 13 to identify a particular portion 43 of the listing which is to be hidden. In one embodiment, the user may select the portion 43 of the program listing 13 by using the usual selection function found with most conventional text editors. Once the portion 43 of the program listing 13 to be hidden has been identified or selected, the user may “right click” on the mouse 22 to call up a context sensitive menu such as shown at 40 in FIG. 3, to enable the user to select from one of three functions, namely hide 45, restore 47 and restore all 49. Alternatively, these functions may be provided as buttons on a toolbar in a text editor window, for example.

On selection of the hide function 45, in this embodiment, the operating system 24 sends a message to the enhancement 32 identifying the function selected and identifying the beginning and end points and more particularly the beginning and ending character positions 51 and 53 respectively of the portion 43 of the program listing 13 to be hidden, as identified by the beginning and ending of the selected portion of the listing.

In an alternative embodiment, the hide function 45 may involve an automated selection routine 15 such as shown in FIG. 4 which may be provided by instructions within the hide segment 33 shown in FIG. 1, for example. To use the automated selection routine 15 the user may simply place the cursor 41 into a particular position on the program listing 13 shown in FIG. 2 and then select the hide function 45 through the menu 40 as shown in FIG. 3, whereupon the CPU 12 is directed to a first block of instructions shown at 42 in FIG. 4 which cause it to parse through the program listing 13 shown in FIG. 2 to identify a context of the portion 43 of the program listing 13 nearest the cursor position. The context of the listing portion 43 refers to the hierarchical level of the function associated with the text of the identified portion. For example, a nested “DO” loop may be comprised of three nested loops, each at a different context level. The text associated with a designated individual loop would be considered text within the same context as the designated individual loop.

To identify the context of the portion 43 of the program listing 13 in proximity to the cursor, the enhancement 32 makes use of the structure of the language in which the program identified by the program listing is written. Thus the rules for identifying context will vary from language to language. Once the context is determined, the beginning 51 and ending 53 character positions of the portion 43 of the common context are located as indicated by block 44 in FIG. 4.

Each computer language written in a prose form imposes a syntactical structure on its elements. Some elements are contained within other elements forming a hierarchy. These hierarchies are useful for defining elements, control structures and limiting scope of identifiers. In one embodiment the closest inner context formed by such a hierarchy may be identified by finding the current position of the cursor. Next the text editor parses through the code in a computer language dependent manner. When the editor reaches the point in the code of the current position of the cursor that context is taken as the common context.

Referring to FIGS. 1 and 5, regardless of how the start and end character positions 51 and 53 of the portion 43 of the program listing 13 which is intended to be hidden are identified, to carry out the process of hiding the identified portion of the listing, block 50 of the hide routine 17 directs the CPU 12 to create a hide record in primary memory 16 and associate the hide record with the program listing 13. The hide record may include fields for holding values representing the start and end character positions 51 and 53 of the portion 43 of the program listing 13 intended to be hidden.

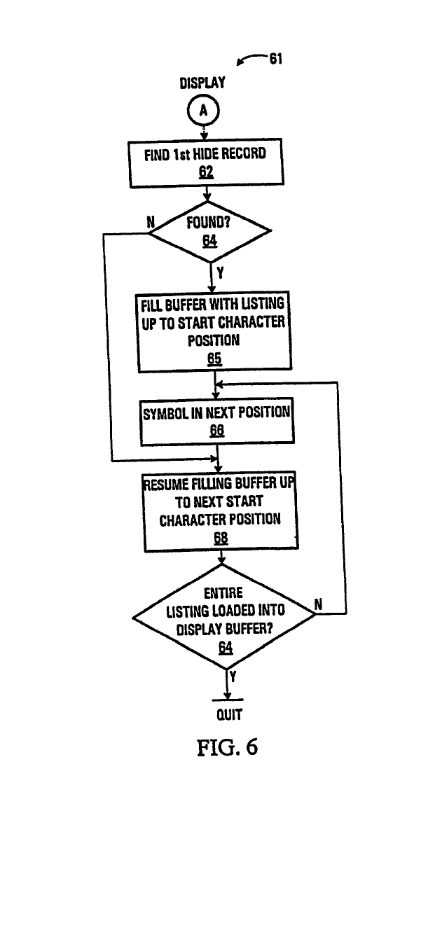

In addition, block 52 directs the CPU 12 to associate a place holder or symbol with the identified portion 43 to be hidden. This may involve providing an index to an icon image or text message, for example. The index may be stored in an index field of the hide record, for example. Block 54 then directs the CPU 12 to refresh the display buffer 25 by causing it to execute a display routine 61 shown in FIG. 6 provided by the display segment 35 shown in FIG. 1.

Referring to FIG. 6, the display routine 61 includes a first block of instructions 62 which direct the CPU 12 to find the first hide record produced by the hide routine shown in FIG. 5 if one exists. At block 64, if a hide record is found, then block 65 directs the CPU 12 to employ the normal display buffer filling routines associated with the conventional text editor 30 to cause the program listing to be loaded into the display buffer 25, up to but not including the character position identified by the start character position 51.

Then block 66 directs the CPU 12 to load the index to the associated symbol into the display buffer 25, beginning at the start character position 51 in the display buffer 25 that would normally be occupied by the first character of the portion to be hidden.

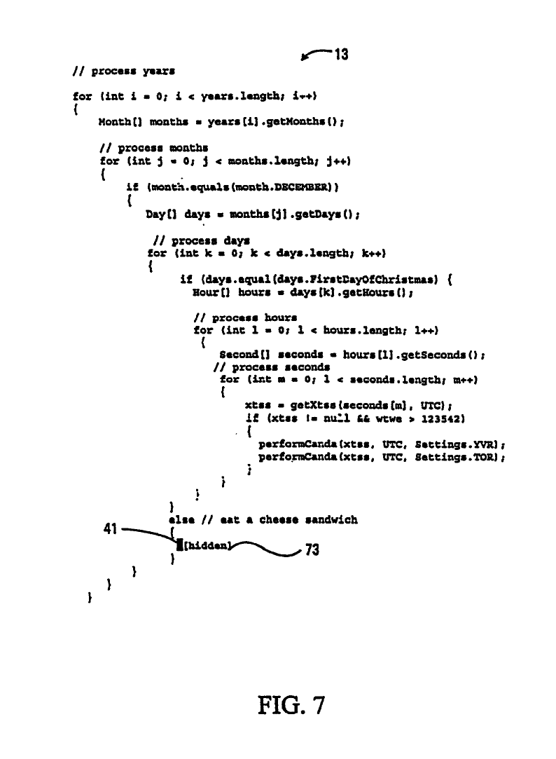

Then, block 68 directs the CPU 12 to go to a position 55 in the program listing, immediately following the end character position 53 identified in the hide record and to resume filling the display buffer 25 from that position, or until a position in the program listing 13 corresponding to a start position of another hidden portion is located. The above process of blocks 66 and 68 is repeated until at block 69 the CPU 12 detects that the entire program listing has been parsed and all identified hidden portions have been replaced with symbol indices in the display buffer 25. Thus, effectively the display buffer 25 is filled with the program listing with the exception that those portions of the program listing which are intended to be hidden are replaced with indices to symbols to indicate that a portion of the program listing is hidden. In the above manner, when conventional display buffer routines within the conventional text editor 30 are executed, the symbol 73 associated with the above-mentioned index is shown on the display 14, in place of the portion 43 of the program listing 13 intended to be hidden, as shown in the simplified program listing shown in FIG. 7. In this embodiment, the symbol 73 is simply a text message comprising the word “hidden” in square brackets, but of course it could be an icon or any other indicator.

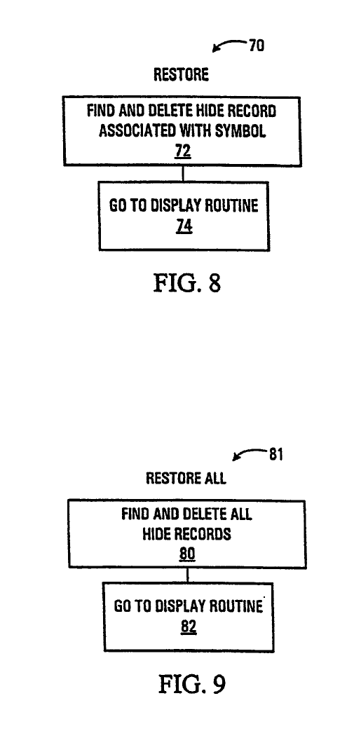

To restore the display of the hidden portions of the program listing 13, the user must first place the cursor 41 in proximity to the symbol 73 identifying a hidden portion of the program listing on the display 14 such as shown in FIG. 7. Then, the user may invoke the context sensitive menu shown in FIG. 3 and select the restore function 47 which invokes a restore routine 70 shown in FIG. 8 provided by the restore segment 37.

The functionality of the restore routine 70 is shown in FIG. 8 and begins with a first block 72 which directs the CPU 12 to find and delete from the primary memory 16 the hide record associated with the symbol proximate to the cursor 41. Block 74 then directs the CPU 12 to refresh the display buffer 25 which causes the display routine shown at 61 in FIG. 6 to be rerun. It will be appreciated that since the hide record which previously existed is now eliminated, the display routine 61 fails to find the hide record associated with the portion 43 of the program listing 13 adjacent the cursor 41 and therefore when refilling the display buffer 25 under the control of the display routine 61, the portion of the program listing that was previously hidden is loaded into the display buffer 25, for display. After the conventional display buffer routines are executed by the conventional text editor 30, the displayed program listing 13 appears as shown in FIG. 2.

Referring back to FIG. 3, if at any time during the display of the program listing 13 the user should invoke the context sensitive menu 40 and select the restore all function 49, a restore all routine 81 provided by the restore all segment 39 shown in FIG. 1 is executed. Referring to FIG. 9 the functionality of the restore all routine 81 begins with a first block 80 which directs the CPU 12 to find and delete all hide records associated with the program listing 13. Block 82 then directs the CPU 12 to execute the display routine 61 shown in FIG. 6 to refill the display buffer 25 such that the symbol indices are replaced with text of the program listing associated with those symbol indices and the remaining text of the program listing 13 is adjusted accordingly. In this way, the entire text of the program listing 13 is restored in the display buffer 25 such that the entire program listing can be displayed by conventional routines.

It will be appreciated that processor readable instructions for providing the functionality provided by the enhanced text editor 28 are stored in the primary memory 16 for use by the CPU 12. The enhancement 32 may be conveyed to the primary memory 16 through a computer readable medium and read by a computer readable media reader 90 shown in FIG. 1, which may include a CD- ROM7 reader, a DVD7 reader, a floppy disk drive or a tape drive, for example. An editor with the enhanced functionality provided by the enhancement 32, or the enhancement alone may be provided on any one of the above-mentioned types of media, as executable instructions stored on such media. Alternatively, the editor 28 with the enhancement 32 or the enhancement alone may be provided in a computer readable signal received at a communications interface 92 shown in FIG. 1, the computer readable signal comprising at least a code segment for directing the CPU 12 to carry out the functionality of the enhancement 32. In this embodiment the communications interface 92 includes a modem to enable computer readable signals to be received from a network such as a public network, such as the internet, or alternatively, a radio frequency or wireless communications interface may be employed to receive such a computer readable signal in a carrier wave transmitted in a wireless system, for example.

While specific embodiments of the invention have been described and illustrated, such embodiments should be considered illustrative of the invention only and not as limiting the invention as construed in accordance with the accompanying claims.

The embodiments of the invention in which an exclusive property or privilege is claimed are defined as follows:

1. A method of simplifying a program listing, the method comprising:
a) receiving an identification of a portion of said program listing to be hidden;
b) receiving input indicating said portion is to be hidden; and
c) causing a symbol to replace said portion of said program listing in response to said identification and said input indicating said portion is to be hidden.

2. The method of claim 1 wherein receiving said identification comprises receiving identifications of a start character position and end character position identifying a beginning and ending respectively of said portion of said program listing to be hidden.

3. The method of claim 2 further comprising determining said start character position and end character position.

4. The method of claim 3 wherein determining said start character position and said end character position comprises identifying a portion of the program listing, which is in a common context.

5. The method of claim 4 wherein determining further comprises identifying a context of said portion, of the program listing, at a cursor position, said context being said common context.

6. The method of claim 5 wherein identifying a context comprises locating a context start marker in proximity to said cursor, determining a hierarchical level of said context start marker and locating a context end marker for the context identified by said context start marker.

7. The method of claim 3 wherein causing comprises associating said portion of said program listing with said symbol.

8. The method of claim 7 wherein associating comprises associating said start character position and said end character position of said portion of said program listing with said symbol.

9. The method of claim 3 wherein associating comprises producing a hide record identifying said start character position and said end character position.

10. The method of claim 3 wherein causing comprises showing said symbol instead of characters between said start character position and said end character position of said program listing when said characters would otherwise be shown.

11. The method of claim 10 wherein showing the symbol comprises loading an index to said symbol at a position in a display buffer which would normally be occupied by the portion to be hidden.

12. The method of claim 10 further comprising locating a hide record identifying said start character position and said end character position.

13. The method of claim 1 further comprising redisplaying at least one hidden portion of the program listing.

14. The method of claim 13 further comprising deleting a hide record associated with said program listing and identifying a portion of the program listing which has been hidden.

15. The method of claim 1 further comprising redisplaying all hidden portions of the program listing.

16. The method of claim 15 further comprising deleting a plurality of hide records associated with said program listing and which identify respective hidden portions of the program listing.

17. An apparatus for simplifying a program listing, the apparatus comprising:
a) a processor circuit having an output device and a text editor for providing a representation of a program listing using said output device;
b) means for receiving an identification of a portion of the program listing to be hidden;
c) means for receiving input indicating that the portion is to be hidden; and
d) means for causing a symbol to replace said portion of said program listing in response to said identification and said input indicating said portion is to be hidden.

18. A computer readable medium for providing processor executable instructions for directing a processor circuit executing a text editor to:
a) receive an indication of a portion of a program listing provided by said text editor to be hidden;
b) receive input indicating said portion is to be hidden; and
c) cause a symbol to replace said portion of said program listing in response to said identification and said input indicating said portion is to be hidden.

19. The computer readable medium of claim 18 further comprising instructions for directing said processor circuit to determine a start character position and an end character position identifying beginning and end points of a portion of said program listing which is to be hidden.

20. The computer readable medium of claim 19 further comprising instructions for directing the processor circuit to determine the start character position and the end character position by identifying a portion of the program listing which is in a common context.

21. The computer readable medium of claim 20 further comprising instructions for directing the processor circuit to identify a context of said portion, of the program listing, at a cursor position, said context being said common context.

22. The computer readable medium of claim 21 further comprising instructions for directing the processor circuit to locate a context start marker of the program listing, in proximity to the cursor, to determine a hierarchical level of said context start marker and to locate a context end marker for the context identified by said context start marker.

23. The computer readable medium of claim 19 further comprising instructions for directing the processor circuit to associate said portion of said program listing with said symbol.

24. The computer readable medium of claim 23 further comprising instructions for directing the processor circuit to associate the start character position and the end character position of the portion of said program listing with said symbol.

25. The computer readable medium of claim 19 further comprising instructions for directing the processor circuit to produce a hide record identifying said start character position and said end character position.

26. The computer readable medium of claim 19 further comprising instructions for directing the processor circuit to show said symbol instead of characters between said start character and said end character of said program listing when said characters would otherwise be shown.

27. The computer readable medium of claim 16 further comprising instructions for directing the processor circuit to load an index to said symbol at a position in a display buffer which would normally be occupied by said portion of said program listing which is to be hidden.

28. The computer readable medium of claim 18 further comprising instructions for directing the processor circuit to redisplay at least one hidden portion of the program listing.

29. The computer readable medium of claim 27 further comprising instructions for directing the processor circuit to delete a hide record associated with said program listing and identify a portion of the program listing which has been hidden.

30. The computer readable medium of claim 18 further comprising instructions for directing the processor circuit to redisplay all hidden portions of the program listing.

31. The computer readable medium of claim 30 further comprising instructions for directing the processor circuit to delete a plurality of hide records associated with said program listing and which identify respective hidden portions of the program listing.

32. An apparatus for simplifying a program listing, the apparatus comprising the computer readable medium of claim 18 and further comprising:
a) a processor circuit having an output device for producing said program listing, and a text editor for causing said program listing to be displayed by said output device; and
b) an input device operable to receive said identification of said portion of the program listing to be hidden.

33. A computer data signal comprising:
a) a first code segment for directing a processor circuit executing a text editor operable to provide a program listing, to receive an identification of a portion of the program listing which is to be hidden;
b) a second code segment for directing the processor circuit to receive input indicating said portion is to be hidden; and
b) a third program portion for directing the processor circuit to cause a symbol to replace said portion of said program listing in response to said identification and said input indicating said portion is to be hidden.
